(19) United States
(12) Patent Application Publication
(10) Pub. No.: US 2026/0233100 A1
(43) Pub. Date: Aug. 13, 2026

(54) ADAPTIVE APPLICATION AUTOMATION BASED ON REAL-TIME STATE ANALYSIS AND MACHINE LEARNING DRIVEN CODE GENERATION

(71) Applicant: ADVANCED MICRO DEVICES, INC., Santa Clara, CA (US)

(72) Inventors: Arun Kumar Ganesan, Bangalore (IN); Sugam Jain, Punjab (IN)

(21) Appl. No.: 19/049,461

(22) Filed: Feb. 10, 2025

(51) Int. Cl. A63F 13/60; G06F 9/54

(52) U.S. Cl. CPC A63F 13/60; G06F 9/541

(57) ABSTRACT

A processing system includes an automation circuit configured to extract, independent of one or more application programming interfaces associated with a computational environment executing at the processing system, application state data representing a current state of the computational environment. The automation circuit is further configured to generate one or more objectives based on application state data representing a current state of a computational environment executing at the processor, and decompose the one or more objectives into a plurality of sub-objectives. The automation circuit is also configured to generate executable code corresponding to the plurality of sub-objectives, and execute the executable code to perform one or more actions in the computational environment.

### BACKGROUND

The evolution of video gaming has brought about increasingly complex environments, dynamic gameplay scenarios, and heightened expectations for immersive experiences. As game worlds become richer and more interactive, the demand for systems that can seamlessly engage with these complexities has intensified. Automation of gameplay, designed to assist or enhance player actions through non-human control, has emerged as an area of focus, addressing needs such as testing, player assistance, and performance optimization. However, traditional approaches to gameplay automation, which heavily rely on hard-coded, rule-based algorithms, have shown limitations. These methods are typically designed to function within fixed parameters, making them effective only in predictable and static gaming scenarios where environmental variables and player behaviors are relatively straightforward.

Modern gaming environments, however, are rarely static or predictable. They often feature intricate storylines, rapidly changing game states, and a multitude of player-driven choices, all of which demand a higher degree of adaptability from automation systems. Hard-coded algorithms struggle to respond to this level of complexity, as they lack the ability to interpret nuanced scenarios or adapt to real-time changes within the game. This rigidity not only restricts their functionality in contemporary games but also curtails their potential to enhance player experiences effectively.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system in accordance with some implementations.

FIG. 2 is a block diagram of an automation engine implemented by the processing system of FIG. 1 in accordance with some implementations.

FIG. 3 is a flow diagram illustrating the interaction and hierarchical workflow of a curriculum design agent, objective critic agent, and task agent within the automation engine of FIG. 2 in accordance with some implementations.

FIG. 4 is a flow diagram illustrating the interaction and hierarchical workflow of an action agent, type-checking agent, and static critic agent within the automation engine of FIG. 2 in accordance with some implementations.

FIG. 5 is a flow diagram illustrating the interaction and hierarchical workflow of a critic agent and annotation agent within the automation engine of FIG. 2 in accordance with some implementations.

FIG. 6 is a diagram illustrating a machine learning (ML) module employing one or more ML models implemented by the automation engine system of FIG. 2 in accordance with some implementations.

FIG. 7 is a flow diagram illustrating a method for dynamically generating and executing gameplay automation tasks in accordance with some implementations.

### DETAILED DESCRIPTION

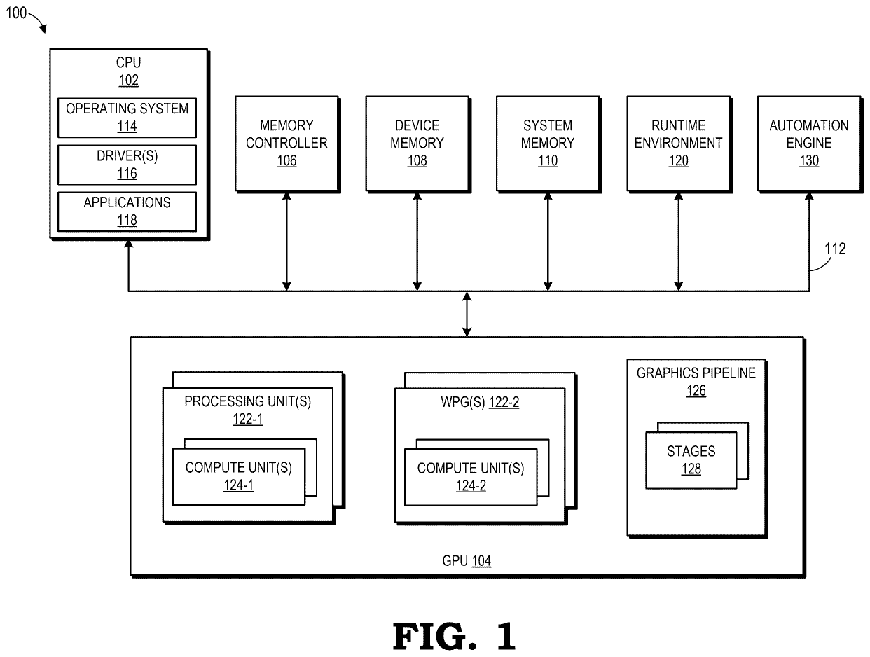

To improve the adaptability and effectiveness of gameplay automation, FIG. 1 to FIG. 7 illustrate systems and methods that leverage techniques to address the challenges of dynamic gaming environments by providing intelligent, context-aware automation capable of real-time decision-making and response to complex game states. As described in greater detail below, the techniques described herein autonomously analyze a game's state, formulate goals based on that analysis, and generate executable code to perform in-game actions while continuously learning and improving through feedback and storing reusable strategies for future use.

For example, a system described herein integrates one or more machine learning (ML) models, such as Large Language Models (LLMs), with at least one automated agent to provide intelligent, adaptive, and autonomous gameplay automation. In at least some implementations, the system uses at least one ML model to analyze real-time game state data (e.g., inventory levels, resources, task history, etc.) and formulate dynamic, contextually relevant objectives aligned with current conditions and past outcomes. These objectives are converted into executable scripts by using a machine learning model(s) to generate code that autonomously executes in-game actions, such as character movement, resource management, and strategic decisions. This ensures seamless adaptation to evolving game scenarios.

This system, in at least some implementations, also uses at least one ML model to maintain the quality of the executable scripts by reviewing and validating the generated code to ensure the code adheres to predefined standards and is robust and reusable. The system evaluates whether objectives are met and provides feedback for continuous improvement, which fosters a learning and adaptation loop. In at least some implementations, the system enriches the validated code with annotations and stores the annotated code in a library to enable the system to recall and reuse strategies for future scenarios.

In addition, the system implements an application programming interface (API) that facilitates the execution of diverse in-game actions across different gaming environments, independent of game-specific APIs. By dynamically interpreting and executing a wide range of actions using one or more ML models, the API enables seamless interaction with and manipulation of game elements. The API's modular and flexible design allows integration with both 2D and 3D game architectures, which broaden the scope of automation across various contexts.

As such, implementations of the described system address challenges, such as dependency on game-specific APIs, unachievable objectives, and the need for human intervention, and offers a framework for adaptive, intelligent, and autonomous gameplay automation. This use of ML models establishes improved game automation, delivers an enhanced gaming experience, and optimizes testing and performance in diverse scenarios.

FIG. 1 is a block diagram illustrating a processing system 100, including an automation component to enable adaptive and autonomous gameplay by, for example, analyzing game data, generating executable scripts, and performing context-aware in-game actions. Although games are used as one illustrative example, the described techniques apply to various other types of applications as well. Also, the number and arrangement of components within the processing system 100 can differ across implementations, with some including more or fewer components than depicted in FIG. 1. Moreover, some implementations may feature additional components not illustrated in FIG. 1 or may organize the system differently. Components of the processing system 100 may be implemented using hardware, circuitry, firmware, software, or any combination thereof.

In the depicted example, the processing system 100 includes a central processing unit (CPU) 102, an accelerated processor (AP) 104, such as a graphics processing unit (GPU), a memory controller 106, a device memory 108 utilized by the AP 104, and a system memory 110 shared by the CPU 102 and the AP 104. In at least some implementations, the CPU 102 and the AP 104 are formed and combined on a single silicon die or package to provide a unified programming and execution environment. However, in other implementations, the CPU 102 and the AP 104 are formed separately and mounted on the same or different substrates.

In at least some implementations, the AP 104 includes any cooperating collection of hardware, software, or a combination thereof that performs functions and computations associated with accelerating graphics processing tasks, data-parallel tasks, nested data-parallel tasks in an accelerated manner with respect to resources, such as conventional CPUs, conventional GPUs, and combinations thereof. For example, in at least some implementations, the AP 104 combines a general-purpose CPU and a graphics processing unit (GPU). In other implementations, the AP 104 includes one or more parallel processors, such as vector processors, GPUs, general-purpose GPUs (GPGPUs), non-scalar processors, highly parallel processors, artificial intelligence (AI) processors, inference engines, machine learning processors, neural processing units (NPUs), intelligence processing units (IPUs), and other multithreaded processing units). In at least some implementations, the AP 104 is a dedicated GPU, one or more GPUs including several devices, or one or more GPUs integrated into a larger device. Additionally, the AP 104, in at least some implementations, includes specialized processors such as digital signal processors (DSPs), field programmable gate arrays (FPGAs), and application-specific integrated circuits (ASICs), which can also be configured for parallel processing tasks.

The memory controller 106, in at least some implementations, includes any suitable hardware for interfacing with memories 108, 110. The memories 108, 110 include any of a variety of random access memories (RAMs) or combinations thereof, such as a double-data-rate dynamic random access memory (DDR DRAM), a graphics DDR DRAM (GDDR DRAM), and the like. The AP 104 communicates with the CPU 102, the device memory 108, and the system memory 110 via a communications infrastructure 112, such as a bus. The communications infrastructure 112 interconnects the components of the processing system 100 and includes one or more of a peripheral component interconnect (PCI) bus, extended PCI (PCI-E) bus, advanced microcontroller bus architecture (AMBA) bus, advanced graphics port (AGP), or other such communication infrastructure and interconnects. In some implementations, communications infrastructure 112 also includes an Ethernet network or any other suitable physical communications infrastructure that satisfies an application's data transfer rate requirements.

As illustrated, the CPU 102 maintains, in memory, one or more control logic modules for execution by the CPU 102. The control logic modules, in at least some implementations, include an operating system (OS) 114, one or more drivers 116 (e.g., a user mode driver, a kernel mode driver, a graphics driver, etc.), and applications 118. These control logic modules control various features of the operation of the CPU 102 and the AP 104. For example, the operating system 114 directly communicates with the hardware and provides an interface to the hardware for other software executing on the CPU 102. The driver(s) 116, including the graphics driver, controls the operation of the AP 104 by, for example, providing an application programming interface (API) to software (e.g., applications 118) executing on the CPU 102 to access various functionality of the AP 104.

For example, in at least some implementations, an application 118 utilizes a graphics API to invoke a driver 116, such as a graphics driver. The driver 116 issues one or more commands to the AP 104 for rendering one or more graphics primitives into displayable graphics images. Based on the graphics instructions issued by the application 118 to the driver 116, the driver 116 formulates one or more graphics commands that specify one or more operations for the AP 104 to perform for rendering graphics. In at least some implementations, the driver 116 is a part of the application 118 running on the CPU 102. In one example, the driver 116 is part of a gaming application running on the CPU 102. In another example, the driver 116 is part of the operation system 114 running on the CPU 102. The graphics commands generated by the driver 116 include graphics commands intended to generate an image or a frame for display. The driver 116 translates standard code received from the API into a native format of instructions understood by the AP 104. Graphics commands generated by the driver 116 are sent to the AP 104 for execution. The AP 104 executes the graphics commands and uses the results to control what is displayed on a display screen.

In at least some implementations, the CPU 102 sends graphics commands, compute commands, or a combination thereof intended for the AP 104 to a command buffer (not shown). Although depicted in FIG. 1 as a separate component for ease of illustration, the command buffer, in at least some implementations, is located in device memory 108, system memory 110, or a separate memory coupled to the communication infrastructure 112. The command buffer temporarily stores a stream of graphics commands that include input to the AP 104. The stream of graphics commands includes for example, one or more command packets and/or one or more state update packets.

The AP 104, in at least some implementations, accepts both compute commands and graphics rendering commands from the CPU 102 or another processor. In at least some implementations, the AP 104 executes commands and programs for selected functions, such as graphics operations and other operations that are particularly suited for parallel processing. In general, the AP 104 is frequently used for executing graphics pipeline operations, such as pixel operations, geometric computations, and rendering an image to a display. In some implementations, the AP 104 also executes compute processing operations (e.g., those operations unrelated to graphics, such as video operations, physics simulations, computational fluid dynamics, etc.) based on commands or instructions received from the CPU 102. For example, such commands include special instructions that are not typically defined in the instruction set architecture (ISA) of the AP 104. In some implementations, the AP 104 receives an image geometry representing a graphics image, along with one or more commands or instructions for rendering and displaying the image. In various implementations, the image geometry corresponds to a representation of a two-dimensional (2D) or three-dimensional (3D) computerized graphics image.

In various implementations, the AP 104 includes one or more processing units 122 (illustrated as processing unit 122-1 and processing unit 122-2). One example of a processing unit 122 is a workgroup processor (WGP) 122-2. In at least some implementations, a WGP 122-2 is part of a shader engine (not shown) of the AP 104. Each of the processing units 122 includes one or more compute units 124 (illustrated as compute unit 124-1 and compute unit 124-2), such as one or more stream processors (also referred to as arithmetic-logic units (ALUs) or shader cores), one or more single-instruction multiple-data (SIMD) units, one or more logical units, one or more scalar floating point units, one or more vector floating point units, one or more special-purpose processing units (e.g., inverse-square root units, since/cosine units, etc.), a combination thereof, or the like. Stream processors are the individual processing elements that execute shader or compute operations. Multiple stream processors are grouped together to form a computer unit or a SIMD unit. SIMD units, in at least some implementations, are each configured to execute a thread concurrently with the execution of other threads in a wavefront (e.g., a collection of threads that are executed in parallel) by other SIMD units, e.g., according to a SIMD execution model. The SIMD execution model is one in which multiple processing elements share a single program control flow unit and program counter and thus execute the same program but are able to execute that program with different data. The number of processing units 122 implemented in the AP 104 is configurable. Each processing unit 122 includes one or more processing elements such as scalar and or vector floating-point units, arithmetic and logic units (ALUs), and the like. In various implementations, the processing units 122 also include special-purpose processing units (not shown), such as inverse-square root units and sine/cosine units.

Each of the one or more processing units 122 executes a respective instantiation of a particular work item to process incoming data, where the basic unit of execution in the one or more processing units 122 is a work item (e.g., a thread). Each work item represents a single instantiation of, for example, a collection of parallel executions of a kernel invoked on a device by a command that is to be executed in parallel. A work item executes at one or more processing elements as part of a workgroup executing at a processing unit 122.

The AP 104 issues and executes work items, such as groups of threads executed simultaneously as a “wavefront” on a single SIMD unit. Wavefronts, in at least some implementations, are interchangeably referred to as warps, vectors, or threads. In some implementations, wavefronts include instances of parallel execution of a shader program, where each wavefront includes multiple work items that execute simultaneously on a single SIMD unit in line with the SIMD paradigm (e.g., one instruction control unit executing the same stream of instructions with multiple data).

The parallelism afforded by the one or more processing units 122 is suitable for graphics-related operations such as pixel value calculations, vertex transformations, tessellation, geometry shading operations, and other graphics operations. A graphics processing pipeline 126 accepts graphics processing commands from the CPU 102 and thus provides computation tasks to the one or more processing units 122 for execution in parallel. In at least some implementations, the graphics pipeline 126 includes a number of stages 128, each configured to execute various aspects of a graphics command. Some graphics pipeline operations, such as pixel processing and other parallel computation operations, require that the same command stream or compute kernel be performed on streams or collections of input data elements. Respective instantiations of the same compute kernel are executed concurrently on multiple compute units 124 in the one or more processing units 122 to process such data elements in parallel. As referred to herein, for example, a compute kernel is a function containing instructions declared in a program and executed on a processing unit 122 of the AP 104. This function is also referred to as a kernel, a shader, a shader program, or a program.

The processing system 100, in at least some implementations, also includes a runtime environment 120, such as an application runtime environment, which provides the execution context for applications 118 and other software components within the processing system 100. Although depicted as a separate component for illustrative purposes, in other implementations, the runtime environment 120 is integrated into other components of the system, such as the CPU 102, the AP 104, the system memory 110, the device memory 108, or a combination thereof.

The runtime environment 120 facilitates the efficient execution of software workloads by providing control logic, memory management, and resource coordination. For example, in at least some implementations, the runtime environment 120 is realized as firmware or middleware residing within the AP 104, directly managing parallel execution units 122. In other implementations, it operates as a software layer within the system memory 110, dynamically allocating memory and processing resources based on application requirements. In some cases, the runtime environment 120 includes hardware-accelerated components within the AP 104, such as dedicated processing pipelines or command schedulers.

This flexibility in implementation allows the runtime environment 120 to optimize for different workloads and system configurations. For instance, in gaming scenarios, the runtime environment 120 may manage physics engines, rendering pipelines, or AI models by leveraging the high-parallelism capabilities of the AP 104. Similarly, in non-graphics workloads, such as machine learning or compute tasks, the runtime environment 120 may handle scheduling and execution coordination directly within the AP 104 or through a combination of the AP 104 and memory controllers 106.

FIG. 1 further shows that the processing system 100 includes an automation engine 130 (also referred to as “automation circuit 130”). The automation engine 130 is designed to enable adaptive and autonomous gameplay automation by performing a series of interrelated tasks that leverage advanced techniques, including the integration of one or more machine learning (ML) models, such as a large language model(s) (LLM) or other types of models. As described below, the automation engine 130 dynamically analyzes real-time game state data, such as inventory, resources, and task history, to assess the current context and identify relevant objectives. These objectives are strategically formulated to align with the evolving conditions of the game and are informed by past successes and failures.

Once the objectives are established, the automation engine 130 generates executable code (e.g., scripts) to perform in-game actions. Using the natural language understanding and generation capabilities of LLMs, the executable is generated to be contextually relevant and tailored to achieve the defined objectives. The automation engine 130 further adapts to changing game conditions by continuously monitoring outcomes and revising its actions as needed, ensuring seamless integration into complex and dynamic gaming environments. For example, the automation engine 130 evaluates one or more outcomes of executing the executable code by comparing pre-execution and post-execution application state data to determine task completion.

In at least some implementations, to maintain the reliability and effectiveness of the generated executable code, the automation engine 130 validates and refines the code. This includes ensuring adherence to predefined standards and identifying potential issues, such as infinite loops or syntax errors, that could impact performance. The validated code are not only robust but also reusable, enabling the system to handle various gaming scenarios efficiently. The automation engine 130 also incorporates a feedback mechanism to evaluate whether the objectives have been successfully achieved. By analyzing the results of executed actions, the automation engine 130 identifies areas for improvement and refines its strategies, fostering a cycle of continuous learning and optimization. This feedback helps the automation engine 130 adapt to the dynamic challenges presented by diverse gaming and other application environments.

The automation engine 130 is also configured to retain learned strategies through the storage of annotated code in a storage, such as a dedicated skill library. This repository allows the system to recall and apply previously successful tactics, improving its performance in future scenarios and enhancing long-term adaptability. The skill library is enriched with descriptive annotations to ensure that the stored strategies are contextually meaningful and ready for reuse.

In at least some implementations, the automation engine 130 is realized using one or more hardware components, circuitry, firmware, or a firmware-controlled microcontroller. Although shown as a separate component in FIG. 1, the automation engine 130 can also be integrated into the CPU 102, the AP 104, or other system components. In other implementations, the automation engine 130 is distributed across multiple components within the processing system 100. In some configurations, the automation engine 130 is implemented on a remote server or within a cloud-based system, providing scalability and efficient operation across various environments. This flexible architecture ensures that the automation engine 130 can meet the needs of a wide range of gaming or other applications.

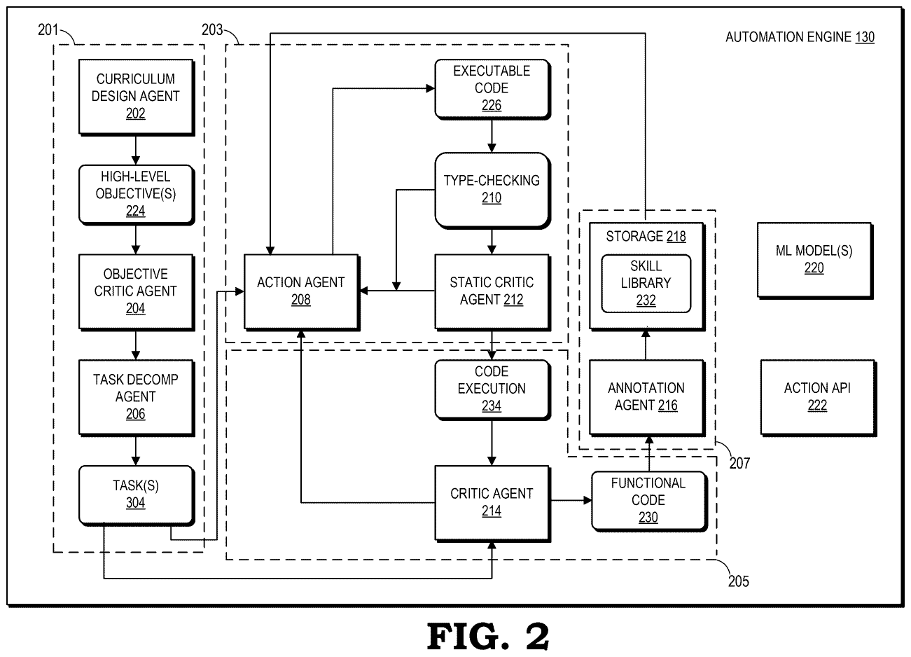

FIG. 2 shows a more detailed view of the automation engine 130. In this example, the automation engine 130 includes (or is coupled to) task-related components 201, action-related components 203, critic-related components 205, skill-related components 207, one or more ML models 220, and an action application programming interface (API) 222. The task-related components 201, in at least some implementations, include a curriculum design agent 202, an objective critic agent 204, a task decomposition agent 206, and the like. The action-related components 203, in at least some implementations, include an action agent 208, a type-checking process 210, and a static critic agent 212. The critic-related components 205, in at least some implementations, include a critic agent 214. The skill-related components, in at least some implementations, include an annotation agent 216 and storage 218. Each of these agents is realized using one or more hardware components, circuitry, firmware, or a firmware-controlled microcontroller. FIG. 2 to FIG. 6 show a detailed view of the curriculum design agent 202, action agent 208, critic agent 214, annotation agent 216, and action API 222, respectively.

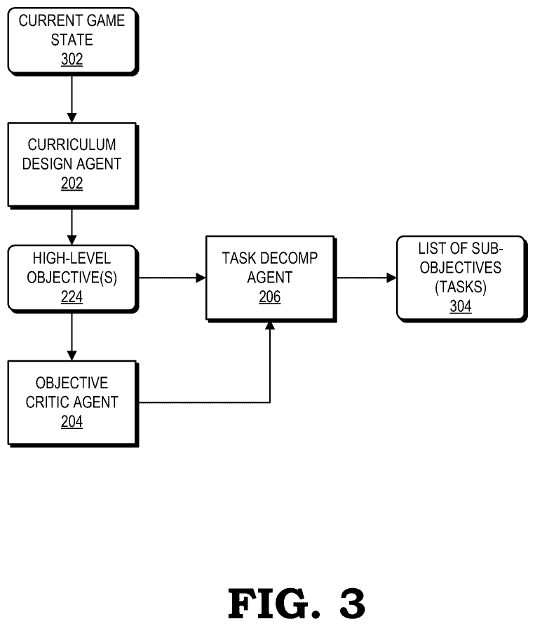

The curriculum design agent 202 is a component of the automation engine 130 and is configured to generate high-level objectives 224 that guide gameplay automation. As shown in FIG. 2 and FIG. 3, the curriculum design agent 202 analyzes the current application state, such as a game state 302, which may include in-game variables, such as inventory levels, resource availability, task history, environmental conditions, and other contextual in-game parameters. By utilizing a reasoning framework, the curriculum design agent 202 evaluates previously completed objectives and analyzes the reasoning behind failed or partially completed tasks. This evaluation enables the agent 202 to dynamically formulate objectives 224 that are contextually relevant, strategically aligned, and adaptable to the evolving game environment.

The curriculum design agent 202 implements one or more machine learning models 220, including large language models (LLMs) 220, to enhance its analysis and objective generation process. These models 220 process complex relationships within the game state 302 and historical data, enabling the curriculum design agent 202 to predict effective objectives 224 and optimize their formulation. By identifying patterns, correlations, and dependencies, the curriculum design agent 202 generates objectives 224 that are not only feasible but also responsive to diverse and dynamic gaming scenarios. For instance, in some implementations, reinforcement learning models analyze patterns in resource availability and enemy positioning to prioritize objectives such as resource collection or defense. In another example, regression models forecast resource requirements, prompting the generation of objectives 224 focused on resource collection when availability is low. In other implementations, LLMs process extensive contextual data from the game state to intelligently infer and generate high-level objectives that align with the system's strategic goals. These models 220 allow the curriculum design agent 202 to predict the outcomes of objectives and adapt dynamically to changing game states.

The machine learning models (including LLMs) 220 also enable the curriculum design agent 202 to incorporate historical performance data into its decision-making processes. This includes evaluating completed objectives and identifying why certain objectives succeeded or failed. By learning from repeated patterns or predicting future challenges, the curriculum design agent 202 adjusts its prioritization and refines its objectives based on these insights. For example, if historical data indicates that objectives related to combat frequently fail due to insufficient resources, the curriculum design agent 202 is able to adjust its prioritization to generate objectives focused on resource accumulation before initiating combat strategies.

Additionally, the machine learning models 220 help the curriculum design agent 202 analyze the broader strategic landscape of the game. In some implementations, clustering algorithms group game state variables to identify priorities, while decision tree models evaluate competing objectives to determine which are most important. This ensures that objectives 224 align with long-term gameplay strategies while remaining flexible to immediate challenges. For example, clustering algorithms may identify groups of objectives related to resource management or combat, enabling the curriculum design agent 202 to prioritize objectives that are most impactful given the current game state. LLMs can holistically evaluate game state variables and historical data to produce nuanced and strategically aligned objectives. This ensures that objectives 224 align with long-term gameplay strategies while remaining flexible to immediate challenges. For example, LLMs infer the need for defensive objectives based on game state descriptions or cluster data from similar scenarios to prioritize impactful objectives.

In at least some implementations, the curriculum design agent 202 adapts objectives 224 dynamically as the game evolves. By continuously updating its analysis of the game state 302, the curriculum design agent 202 ensures that generated objectives 224 remain relevant and feasible under changing conditions. For instance, a decision tree model, in at least some implementations, determines that an offensive strategy is no longer viable due to resource depletion and recommends defensive or retreat objectives instead. In another example, the LLMs dynamically re-evaluate high-level objectives based on textual and numeric game state inputs to refine strategies as the game progresses. This contextual adaptation allows the curriculum design agent 202 to respond intelligently to dynamic computational environments, such as gaming environments.

Feedback integration is another feature of the curriculum design agent 202. One or more machine learning models 220 integrated into the agent 202 incorporate feedback from other components, such as the objective critic agent 204 and the task agent 206, to refine future objective generation. This iterative learning loop enables the curriculum design agent 202 to continuously improve the quality and adaptability of its outputs. For example, a neural network is able to adjust its weighting of certain game state variables based on feedback indicating that previous objectives were overly complex or misaligned with gameplay strategy. In another example, one or more LLMs incorporate detailed critique from the objective critic agent 204 to refine objective formulation processes, while neural networks are able to adjust the weighting of certain game state variables based on feedback indicating that previous objectives were overly complex or misaligned with gameplay strategy.

The curriculum design agent 202 interfaces with the objective critic agent 204, which evaluates the feasibility and achievability of the generated objectives 224. This collaboration forms a feedback loop where infeasible or suboptimal objectives are refined, enhancing the overall quality of the objectives passed to downstream components such as the task agent 206. For example, if the objective critic agent 204 identifies resource limitations, the curriculum design agent 202 adjusts objectives 224 to include preparatory tasks such as gathering additional materials. In implementations that include LLMs, the curriculum design agent 202 also processes detailed feedback in natural language, improving its ability to refine and contextualize objectives.

After processing data through the machine learning models (including LLMs) 220, the curriculum design agent 202 formulates high-level objectives 224 tailored to the context of the game. These objectives are passed to the objective critic agent 204 for validation, ensuring they are achievable, aligned with player or system goals, and capable of being decomposed into manageable sub-objectives.

By continuously refining its outputs based on feedback and validated results, the curriculum design agent 202 enables an adaptive and intelligent automation system. The curriculum design agent 202 ensures that the system can address dynamic gaming challenges by generating objectives 224 that are both actionable and aligned with the evolving needs of the game environment. This dynamic and iterative approach transcends static, rule-based systems, allowing the curriculum design agent 202 to respond intelligently to complex and unpredictable gaming scenarios.

Examples of machine learning models 220 used by the curriculum design agent 202 include reinforcement learning for real-time decision-making and adaptation, supervised learning to analyze historical data and predict outcomes, unsupervised learning to cluster related game state variables, neural networks to process complex relationships, decision trees to evaluate and select objectives based on predefined rules or learned thresholds, a combination thereof, and the like. LLMs further enhance the agent's capabilities by analyzing textual descriptions of the game state, synthesizing strategies, or inferring novel objectives that align with player or system goals. These models 220 enable the curriculum design agent 202 to intelligently formulate, contextually adapt, and dynamically generate high-level objectives 224 that provide a robust foundation for the automation engine 130.

As shown in FIG. 2 and FIG. 3, the objective critic agent 204 is a component of the automation engine 130 configured to validate and refine the high-level objectives 224 generated by the curriculum design agent 202. This validation process involves analyzing the feasibility, achievability, and relevance of each objective in light of the current game state 302 and known constraints within the game environment. The objective critic agent 204 assesses variables such as resource availability, environmental conditions, and task dependencies to determine whether an objective is actionable within the context of the game.

In at least some implementations, the objective critic agent 204 implements one or more reasoning frameworks and machine learning models 220, including LLMs, to analyze why similar objectives have succeeded or failed in the past. By examining historical performance data, the objective critic agent identifies risks and potential pitfalls associated with a given objective. For example, if an objective to construct a defensive structure failed previously due to resource shortages, the objective critic agent 204 flags similar objectives for refinement, ensuring adequate preparatory tasks are included in subsequent iterations. This process allows the objective critic agent 204 to refine overly ambitious objectives or objectives that are misaligned with the game's strategic goals, providing detailed feedback to the curriculum design agent 202 to improve the formulation of future objectives. In some implementations, LLMs analyze textual feedback from prior tasks or natural language descriptions of objectives to enhance the evaluation process by inferring nuances that may not be captured by traditional models.

In at least some implementations, the objective critic agent 204 uses predictive modeling and LLM capabilities to evaluate the likelihood of success for each objective based on current and historical data. For example, a regression model is able to estimate the time and resources required to achieve an objective, enabling the objective critic agent 204 to determine if the objective is feasible given the current game state. Additionally, clustering models are able to group objectives with similar characteristics to streamline the validation process and identify patterns in objective performance. In other implementations, LLMs process structured data alongside natural language inputs, such as descriptions of player strategies or environmental constraints, to holistically evaluate the objective's alignment with gameplay goals.

The objective critic agent 204 also dynamically adapts its validation process as the game evolves. By integrating real-time updates from the game state 302, the agent 204 can adjust its evaluation criteria to account for changes in resource availability, environmental conditions, or player actions. For example, a decision tree model is able to recommend modifying objectives if it detects significant shifts in game conditions, such as an unexpected depletion of resources or a new threat in the environment. This adaptability ensures that objectives remain achievable and aligned with the game's strategic needs. In other implementations, LLMs interpret real-time textual or numeric inputs describing game state changes to recommend refinements to objectives in a contextually aware manner.

In at least some implementations, the objective critic agent 204 incorporates one or more of reinforcement learning models or LLMs to improve its validation and refinement processes over time. These models enable the agent to learn from the outcomes of past objectives, adapting its evaluation framework to better predict feasibility and identify potential obstacles. For instance, if objectives with insufficient preparatory tasks consistently fail, the objective critic agent 204 learns to prioritize the inclusion of resource-gathering sub-objectives before executing more complex goals. Similarly, LLMs may analyze historical objective data and feedback to identify recurring issues or suggest alternative strategies in natural language, enabling continuous improvement in the agent's evaluation process.

Once an objective has been validated, the objective critic agent 204 forwards it to the task agent 206 for decomposition into manageable sub-objectives. This ensures that only objectives meeting predefined criteria for feasibility, relevance, and strategic alignment are processed further. For example, if an objective to construct a specific game structure passes validation, the task agent 206 decomposes it into sub-objectives 304 (FIG. 3) such as gathering materials, navigating to the construction site, and initiating the build process.

The collaboration between the objective critic agent 204 and the curriculum design agent 202 forms a feedback loop that enhances the overall adaptability and intelligence of the automation system. Feedback from the objective critic agent enables the curriculum design agent 202 to refine its formulation of high-level objectives, improving the ability of the automation engine 130 to respond to complex and dynamic gaming environments. For instance, if the objective critic agent 204 determines that resource constraints consistently prevent the completion of certain objectives, the curriculum design agent 202 may adjust its prioritization to focus on resource accumulation in future iterations. LLMs facilitate this feedback loop by interpreting and synthesizing feedback in natural language, making it more accessible and actionable for the curriculum design agent 202.

By continuously validating and refining high-level objectives 224, the objective critic agent 204 ensures that the automation system operates efficiently and effectively. The ability of the objective critic agent 204 to analyze feasibility, incorporate historical and real-time data, and adapt to evolving game conditions enables the system to address diverse and dynamic gameplay challenges with precision. In implementations using LLMs, the objective critic agent 204 further enhances its capabilities by leveraging natural language processing to provide contextually rich evaluations and recommendations.

Examples of machine learning models 220 used by the objective critic agent 204 include regression models to predict resource requirements and estimate the time needed to achieve objectives, clustering models to group similar objectives and identify patterns in their success or failure rates, decision trees to evaluate the feasibility of objectives under predefined rules and game constraints, reinforcement learning models to iteratively improve the validation process based on feedback from completed objectives, LLMs to process textual feedback, infer contextual insights, and synthesize recommendations for refining objectives, a combination thereof, and the like.

By leveraging these machine learning models and reasoning frameworks, the objective critic agent 204 enhances the ability of the automation engine 130 to validate, refine, and prioritize objectives, ensuring a robust foundation for downstream components such as the task agent 206. This iterative and adaptive approach allows the automation engine 130 to operate with intelligence and precision in complex and unpredictable gaming environments.

As shown in FIG. 2 and FIG. 3, the task agent 206 is a component of the automation engine 130 and is configured to decompose validated high-level objectives 224 into a detailed list of sub-objectives 304. This decomposition process allows complex objectives to be broken into smaller, actionable tasks that can be executed efficiently by downstream components, such as the action agent 208. The task agent 206 works in conjunction with the curriculum design agent 202 and the objective critic agent 204 to ensure that the generated sub-objectives are actionable, precise, and aligned with the broader gameplay strategy.

The task agent 206 implements one or more machine learning models 220, including LLMs, to optimize the decomposition process dynamically, ensuring that the sub-objectives 304 remain relevant and feasible under the current game state 302. These machine learning models 220 analyze a range of contextual variables, including resource availability, environmental conditions, task history, and game-specific constraints, to adapt the decomposition process in real-time. For example, in at least some implementations, a clustering model groups related tasks to streamline decomposition, while a decision tree model evaluates the dependencies between objectives to prioritize and structure sub-objectives effectively. LLMs enhance this process by interpreting complex relationships in the game state and generating contextually informed sub-objectives in natural language or code.

In at least some implementations, the task agent 206 employs one or more of reinforcement learning models or LLMs to iteratively improve its ability to generate effective sub-objectives 304 based on feedback from downstream components, such as the action agent 208 or critic agent 214. Reinforcement learning models adapt the decomposition process by learning from prior task execution outcomes, while LLMs enable the task agent 206 to interpret and incorporate detailed feedback in natural language or structured formats. For instance, if inefficiencies in task execution are identified by the critic agent 214, the task agent 206, in at least some implementations, uses reinforcement learning to refine the sequence or structure of sub-objectives. Simultaneously, LLMs synthesize the feedback into actionable insights, improving the precision of future sub-objective generation. Therefore, the task agent 206 is configured to dynamically adapt the of sub-objectives 304 based on real-time changes in the game state data during execution of the executable code 226.

In at least some implementations, the task agent 206 incorporates one or more predictive modeling or LLMs to anticipate the requirements and dependencies of sub-objectives 304 based on the validated high-level objective 224 and the current game state 302. For instance, predictive models analyze structured data to forecast resource needs and task durations, while LLMs process natural language descriptions of game objectives to identify additional contextual dependencies. If a high-level objective involves constructing a defensive structure, the task agent 206 generates sub-objectives 304, such as gathering materials, identifying a suitable location, and executing the build process. The combination of predictive models and LLMs ensures that the task agent 206 accounts for resource constraints, environmental conditions, and potential challenges, resulting in sub-objectives that are both actionable and achievable.

The task agent 206 also adapts to evolving game conditions by dynamically modifying sub-objectives 304 as the game progresses. In at least some implementations, this dynamic updating of the sub-objectives is performed in real time. In at least some implementations, machine learning models 220 and LLMs enable the task agent 206 to update sub-objectives 304 in response to changes in resource availability, enemy activity, or other game variables. For example, if an objective to gather resources becomes infeasible due to a sudden depletion of nearby resources, clustering models may identify alternative resource-rich areas, while LLMs suggest refined sub-objectives to navigate to those areas efficiently. This adaptability ensures that the decomposition process remains aligned with real-time game dynamics.

The decomposition process performed by the task agent 206 is iterative and, in at least some implementations, involves collaboration with the curriculum design agent 202 and the objective critic agent 204. For example, the task agent 206 refines sub-objectives 304 based on feedback from the critic agent 214, ensuring that each sub-objective aligns with the broader strategic goals and is executable under the constraints of the current game state. LLMs further enhance this feedback loop by processing feedback in natural language, synthesizing actionable insights, and re-evaluating the generated sub-objectives to ensure contextual relevance. This feedback loop enhances the ability of the task agent 206 to adapt and improve over time, enabling the task agent 206 to address the complexities of modern gaming environments effectively.

The task agent 206 ensures seamless integration with other components of the automation engine 130. Sub-objectives 304 generated by the task agent 206 are passed to the action agent 208 for execution, providing a clear and structured workflow that supports the efficient operation of the system. By producing sub-objectives 304 that are well-defined and feasible, the task agent 206 enables downstream components to operate with precision and efficiency.

Examples of machine learning models 220 used by the task agent 206 include reinforcement learning models to iteratively refine the decomposition process based on feedback from executed tasks, clustering models to group related tasks and identify patterns for streamlined decomposition, predictive models to forecast the requirements and dependencies of sub-objectives 304 based on the current game state and high-level objectives 224, decision trees to evaluate dependencies and prioritize sub-objectives 304 for efficient execution, LLMs to interpret game state data, process textual descriptions of objectives, and generate sub-objectives that are contextually informed and strategically aligned, a combination thereof, or the like. By leveraging these machine learning models, the task agent 206 ensures that sub-objectives are dynamically adapted to the current game state and strategic goals. This iterative and adaptive approach allows the task agent 206 to efficiently break down complex objectives into manageable tasks, supporting the broader automation engine's ability to address diverse and dynamic gaming challenges.

The configuration of the task agent 206 design ensures robust integration and adaptability, providing a foundation for the execution of high-level objectives 224 through precise and actionable sub-objectives 304. The task agent's dynamic and context-aware decomposition process enables the automation engine 130 to respond intelligently to the evolving complexities of modern gaming environments.

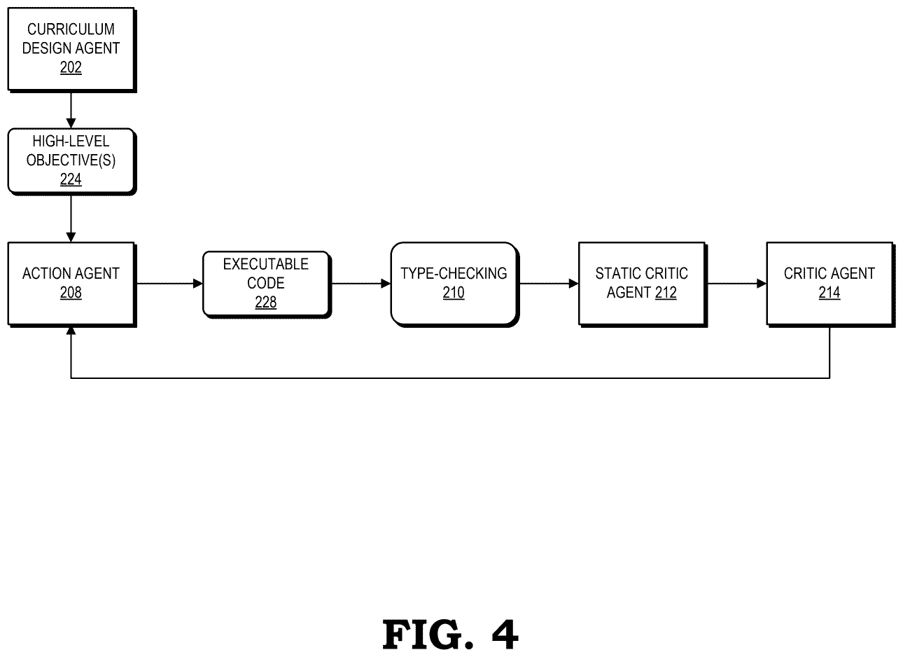

As shown in FIG. 2 and FIG. 4, the action agent 208 is a component of the automation engine 130 tasked with the generation of executable code 228 tailored to achieve the high-level objectives 224 formulated by the curriculum design agent 202 and refined by the objective critic agent 204. The action agent 208 translates these high-level objectives into executable code 228, ensuring the seamless transition from abstract goals into actionable code that can perform tasks autonomously within the gaming environment. This process bridges the gap between strategic planning and operational execution, enabling the automation engine 130 to interact intelligently with the game.

In at least some implementations, the action agent 208 leverages one or more machine learning models 220, including LLMs, to enhance its code generation capabilities. Machine learning models analyze patterns in previous executions, identify dependencies, and recommend efficient implementations for complex tasks, while LLMs provide natural language understanding and generation capabilities that facilitate dynamic and adaptive code creation. For example, the action agent 208 receives a high-level objective such as “optimize resource collection” and, using an LLM, generates executable code 228 for navigating to resource-dense areas, gathering resources, managing inventory, and the like. The LLMs enable the action agent 208 to process abstract objectives in natural language, convert them into structured actions, and produce syntactically correct and contextually relevant code 228 in one or more programming languages.

To ensure the executable code 228 is of high quality and consistent with best practices, the action agent 208 implements or interacts with the type-checking process 210. In other embodiments, a separate type-checking agent performs the type-checking process described herein. The type-checking process 210 performs static analysis on the generated executable code 228, identifying type mismatches, undefined variables, or improperly structured functions. For example, if the generated executable code 228 involves a function expecting an integer but is passed a string, the type-checking process 210 detects this inconsistency and flags it for correction. The feedback from the type-checking process 210 enables the action agent 208 to refine the executable code 228 before forwarding it to the next stage, enhancing reliability and reducing runtime errors.

The action agent 208 collaborates with the static critic agent 212 to ensure compliance with established coding standards and optimize code quality. The static critic agent 212 evaluates the executable code 228 for structural issues such as infinite loops, recursion, inefficient algorithms, and the like. For instance, if the generated executable code 228 involves a redundant loop that could hinder performance, the static critic agent 212 identifies this inefficiency and recommends optimization. The iterative feedback provided by the static critic agent 212 helps the action agent produce code that is modular, maintainable, and optimized for scalability across various gaming scenarios.

Feedback is also received from the critic agent 214 based on execution 234 of the code 228. For example, the critic agent 214 assesses the outcomes of executing the code 228 and provides actionable insights for improving the generated executable code 228. For example, if the critic agent 214 identifies delays in resource collection due to suboptimal navigation logic, the action agent 208 adapts its code generation process to improve pathfinding algorithms in subsequent iterations. This feedback loop ensures that the action agent 208 continuously learns from prior performance, enabling it to adapt to evolving game dynamics and refine its code generation process over time.

In at least some implementations, the action agent 208 employs one or more of predictive models, LLMs, and the like to anticipate potential challenges and requirements during code execution. For example, if the game state indicates limited resources, predictive models suggest generating code that prioritizes resource efficiency. Similarly, LLMs process contextual data from the game environment and synthesize strategies for handling unexpected scenarios, such as enemy attacks or environmental changes. These combined capabilities enable the action agent to proactively address challenges and maintain alignment with broader gameplay strategies.

By dynamically generating, validating, and refining executable code 228, the action agent 208 helps bridge high-level objectives with actionable commands. The action agent 208 ensures that the automation engine 130 operates with precision and efficiency but also enhances adaptability by learning from feedback and continuously improving its processes. The action agent's ability to leverage machine learning models 220, including LLMs, combined with its integration with other validation agents, allows the automation engine 130 to navigate complex and evolving game scenarios effectively.

As shown in FIG. 2 and FIG. 4, the type-checking process 210 is a component of the automation engine 130 and is configured to validate the executable code 228 generated by the action agent 208. The type-checking process 210 performs static analysis of the executable code 228, ensuring that it adheres to programming standards, is free from type mismatches, and is consistent with predefined structural requirements. By acting as an intermediary validation layer, the type-checking process 210 contributes to the robustness and reliability of the automation engine, reducing the potential for runtime errors and inefficiencies.

As described above, the type-checking process 210 is provide by one or more of the agents to tools that provide comprehensive static type-checking capabilities for code. The type-checking process 210 analyzes the syntax, structure, and type definitions of the executable code 226. For example, the type-checking process 210 flags issues such as type mismatches where variables are assigned with incompatible types, such as assigning a string to a variable that is expected to hold an integer; undefined variables, which are variables referenced in the code that are not declared or initialized; missing function parameters, such as when functions that are called without providing the required arguments; inconsistent return types, such as functions that return a type that does not align with their declared type annotations; and the like. These checks help ensure that the generated code is syntactically correct, structurally consistent, and aligned with best practices for type safety. By catching these errors early, the type-checking process 210 reduces the likelihood of failures during code execution.

In at least some implementations, the type-checking process 210 operates in real-time as the action agent 208 generates executable code. The type-checking process 210, in at least some implementations, provides immediate feedback to the action agent 208, highlighting errors or inconsistencies and suggesting corrections. For example, if the generated code 228 involves a function that expects a list but receives a dictionary, the type-checking process 210 identifies this mismatch and provides a detailed report to the action agent 208 for refinement. This iterative feedback mechanism ensures that the action agent 208 produces higher-quality code before the code 228 is passed to subsequent validation stages.

The type-checking process 210, in at least some implementations, also enforces compliance with predefined programming standards, such as adhering to coding style guides or ensuring proper use of type annotations. For example, the type-checking process 210 checks that all functions include explicit type annotations for their parameters and return values, ensuring clarity and maintainability in the generated code.

In some implementations, the type-checking process 210 incorporates one or more machine learning models 220, including LLMs, to enhance its capabilities. For instance, ML models 220 analyze historical data to identify patterns in common coding errors and predict potential issues based on the generated code structure. LLMs interpret complex error messages or ambiguous code structures and provide natural language explanations or suggestions for improvement. For example, an LLM analyzes a detected error and proposes alternative code snippets that resolve the issue while maintaining functionality.

After completing its analysis, the type-checking process 210 forwards the validated code to the static critic agent 212 for further review. This ensures that only syntactically sound and structurally consistent code progresses to the next validation stage. By acting as a filter, the type-checking process 210 reduces the workload of the static critic agent 212, allowing the static critic agent 212 to focus on higher-level issues, such as logical correctness and compliance with coding standards.

The intermediate validation layer of the type-checking process 210 enhances the overall reliability and quality of the automation engine 130. By identifying and addressing issues at the type and syntax level, type-checking process 210 minimizes the risk of downstream errors, improves code maintainability, and ensures smoother execution within the gaming environment. This proactive approach to error detection and resolution allows the automation engine to operate with greater precision and efficiency, contributing to its adaptability in complex and dynamic gaming scenarios.

As shown in FIG. 2 and FIG. 4, the static critic agent 212 is a component of the automation engine 130, tasked with evaluating the executable code 228 generated by the action agent 208 to ensure compliance with established coding standards and best practices. Building on the foundational analysis performed by the type-checking process 210, the static critic agent 212 focuses on the logical, structural, and performance aspects of the code 228 to ensure it is robust, efficient, and optimized for execution in dynamic gaming environments.

The static critic agent 212 conducts a comprehensive review of the executable code 228 to identify potential inefficiencies and structural weaknesses. In at least some implementations, the static critic agent 212 examines the code for inefficient loops or recursion. For example, the static critic agent 212 detects infinite loops, poorly structured recursive functions, or loops with excessive iterations that could degrade system performance or lead to runtime failures. The static critic agent 212 also identifies any unnecessary complexity. For example, the static critic agent 212 highlights convoluted logic, redundant operations, or poorly structured code that complicates maintenance and readability. The static critic agent 212 also checks for modular design, ensuring that the code 228 is broken into smaller, reusable functions that adhere to principles of modularity and abstraction. The static critic agent 212 further checks for input/output consistency. For example, the static critic agent 212 verifies that functions in the code 228 include well-defined input parameters and output values to promote clarity and interoperability with other system components. For example, if the code 228 includes a nested loop that redundantly processes the same dataset, the static critic agent 212 flags this inefficiency and suggests a more optimized approach, such as reducing loop depth or leveraging built-in data processing functions.

In at least some implementations, the static critic agent 212 incorporates one or more machine learning models 220, including LLMS, to further enhance its evaluation capabilities. For example, the machine learning models analyze historical performance data to identify patterns in inefficient code structures or logical errors, allowing the static critic agent to refine its evaluation criteria. The LLMs provide context-aware analysis of code, identifying subtle inefficiencies or non-standard practices that traditional models may overlook. For instance, an LLM can parse the entire executable code 228, understand its intent, and suggest more concise or efficient implementations. In addition to identifying inefficiencies, the static critic agent 212 ensures that the code adheres to industry-standard coding guidelines. This includes enforcing consistent naming conventions, appropriate documentation within the code, and adherence to style requirements, which collectively improve maintainability and readability.

Once the static critic agent 212 completes its analysis, the static critic agent 212 provides detailed feedback to the action agent 208. This feedback, in at least some implementations, includes recommendations for simplification, such as suggesting streamlined alternatives for overly complex logic or redundant operations; recommendations for structural improvements, such as proposing the decomposition of large functions into smaller, reusable modules; recommendations for error corrections, such as highlighting logical inconsistencies or gaps in the code 228 that may lead to runtime errors or unintended behavior; and the like. For instance, if the executable code 228 includes a function with multiple responsibilities, the static critic agent 212 recommends splitting the code 228 into smaller, single-responsibility functions to align with the principles of clean code design.

The static critic agent 212 helps provide an iterative refinement within the automation engine 130. By collaborating with the action agent 208, the static critic agent 212 ensures that the generated executable code 228 evolves through multiple iterations, incorporating feedback and aligning with coding best practices. For example, if the static critic agent 212 identifies inefficiencies in the code 228, the action agent 208 refines its generation process, producing a revised version that addresses the identified issues.

In at least some implementations, the static critic agent 212 adapts its evaluation criteria dynamically based on feedback from the critic agent 214. For example, if the critic agent 214 observes recurring failures in task execution due to suboptimal code structure, it provides insights that help the static critic agent 212 refine its validation rules, ensuring that future code evaluations address these shortcomings more effectively.

By enforcing stringent quality standards and providing actionable feedback, the static critic agent 212 ensures that the executable code 228 is robust, efficient, and maintainable. For example, the static critic agent 212 ensures that the code 228 is free from common errors and designed to handle edge cases effectively, optimized for performance in terms of time and resource usage, and designed with clarity, modularity, and adherence to coding standards, allowing for easy updates and integration with other components.

As such, the static critic agent 212 helps ensure that the executable code 228 is of high quality and optimized for execution, enabling the system to operate effectively in diverse and dynamic gaming scenarios. By combining code analysis techniques with one or more of advanced machine learning and LLM capabilities, the static critic agent 212 contributes to the overall intelligence, adaptability, and precision of the automation engine 130.

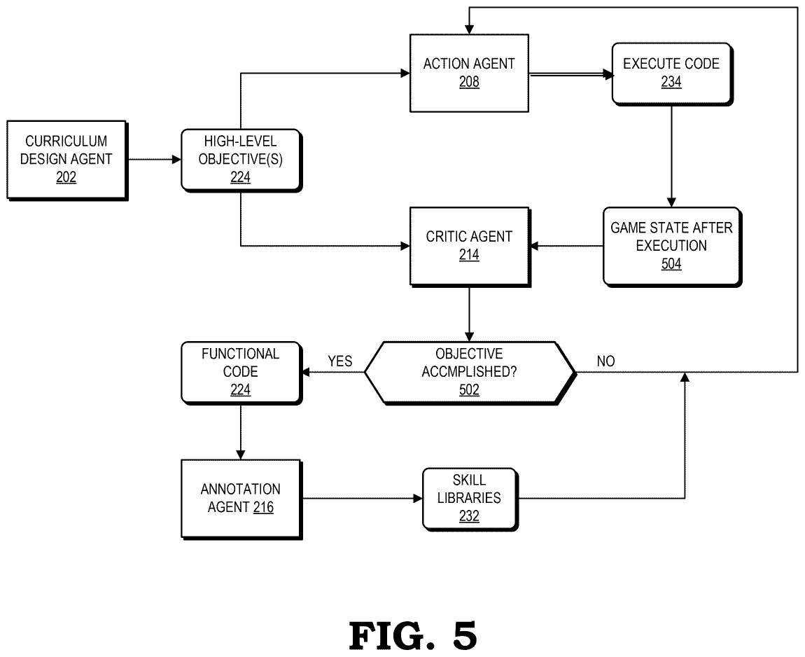

As shown in FIG. 2 and FIG. 5, the critic agent 214 is a component of the automation engine 130 responsible for evaluating the outcomes of executed tasks from the executable code 228 and providing detailed feedback to enhance the adaptability, precision, and efficiency of the automation engine 130. After an execution 234 of the executable code 228, the critic agent 214 performs an evaluation 502 whether the executable code 228 (immediate task-specific code sent for execution) successfully achieves the intended high-level objectives 224 based on, for example, a current state 504 of the game resulting from executing the code 508. Based on its evaluation, the critic agent 214 generates actionable feedback to refine code generation and execution processes if the high-level objections 224 were not achieved. If the high-level objections 224 were achieved, the critic agent 214 sends a validated version of the executable code 228, herein referred to as functional code 230, to the annotation agent 216 for further processing. This functional code 230 is later enriched and stored in the skill (also referred to herein as “stored library 232”) as reusable code components for future reuse. The reusable code components are associated with previously validated functional code and are relevant to one or more objectives. In at least some implementations, the analysis performed by the critic agent 214 considers both successful and failed attempts, fostering continuous improvement through a feedback-driven learning loop.

In at least some implementations, the critic agent 214 implements one or more machine learning models 220, including LLMS, to analyze task outcomes. These models 220 allow the critic agent 214 to process both structured data (e.g., performance metrics, error rates, and the like) and unstructured data (e.g., execution logs, natural language feedback, and the like) to generate actionable insights. For example, if a resource-gathering task fails due to suboptimal navigation logic, the critic agent 214 identifies the issue and provides recommendations to refine the generated executable code 228 or modify future objectives. In another example, LLMs interpret textual feedback or error logs and produce contextually rich feedback, highlighting inefficiencies or suggesting alternative strategies to achieve the objectives more effectively.

The critic agent 214 collaborates with the action agent 208, providing feedback on task execution to enhance the quality of future executable code 228. This iterative process ensures that the action agent 208 refines its code generation logic based on real-world outcomes. For example, if the critic agent 214 identifies redundant operations in a navigation routine, the critic agent 214 recommends optimizing the pathfinding logic to reduce execution time and improve efficiency. If a task consistently fails due to insufficient resource preparation, the critic agent 214 suggests that the action agent 208 include additional preparatory steps, such as gathering necessary materials, in future code generation processes.

The critic agent 214 also works with the static critic agent 212 to refine its validation framework based on observed execution outcomes. This collaboration enhances the automation engine's ability to catch inefficiencies earlier in the pipeline. For example, if the critic agent 214 identifies recurring inefficiencies in resource collection, the critic agent 214 provides feedback to the static critic agent 212 to update its checks for logical consistency and efficiency. Also, if logical inconsistencies or gaps in task execution are detected, the critic agent 214 suggests improvements to the static critic agent's validation process to ensure future executable code 228 is robust and reliable.

The critic agent 214 dynamically adapts its evaluation criteria based on real-time updates to the game state 302, ensuring its assessments remain relevant as the game environment evolves. For example, if an unexpected event, such as an enemy attack, disrupts task execution, the critic agent 214 recommends modifying future objectives to prioritize defensive actions or mitigate the impact of the disruption. In another example, LLMs integrated into the critic agent 214 interpret real-time updates expressed in natural language or numeric formats, providing adaptive recommendations such as shifting priorities from offensive to defensive strategies in response to changes in the game state.

In at least some implementations, the critic agent 214 incorporates one or more reinforcement learning models and LLMs to improve its evaluation and feedback processes over time. These models 220 enable the critic agent 214 to learn from past outcomes and refine its evaluation framework to better predict success or failure factors. For example, reinforcement learning models adapt the critic agent's decision-making framework by identifying recurring obstacles or inefficiencies and prioritizing strategies that address these issues. LLMs synthesize historical data and feedback into natural language explanations or alternative strategies, providing actionable insights that are easy to interpret and implement.

After completing its evaluation, the critic agent 214 produces functional code 230 based on the executable code 228, enriched with success criteria, identified issues, and lessons learned. This functional code is passed to the annotation agent 216, which further enhances it with contextual metadata before storing it in the skill library 232. The skill library 232 serves as a repository of reusable strategies and insights for future tasks, enabling the automation engine 130 to continuously refine and improve its performance in diverse and dynamic gaming scenarios. For example, if a specific defensive strategy proves effective, the annotation agent 216 documents the key success factors, enabling the system to replicate the strategy in similar scenarios. If a resource-gathering task fails due to pathfinding issues, the annotation agent 216 annotates the functional code 230 with recommendations for improved navigation logic, ensuring future iterations avoid the same problems.

The ability of the critic agent 214 to process diverse data sources, adapt to evolving game conditions, and integrate feedback ensures a continuous learning loop that enhances system performance. By refining the generation and task validation processes of the functional code 230, the critic agent 214 contributes to the ability of the automation engine 130 to adapt to dynamic and complex gaming scenarios.

As shown in FIG. 2 and FIG. 5, the annotation agent 216 is a component of the automation engine 130 configured to enhance the functional code 230 produced by the critic agent 214 by appending rich, contextual metadata and detailed annotations. These annotations encapsulate an execution context, such as the reasoning processes, execution results, and lessons learned from previous tasks, associated with the executable code, and ensures that the automation engine 130 builds a robust and context-aware knowledge base for future use.

In at least some implementations, the annotation agent 216 receives the functional code 230 from the critic agent 214 and enhances the code 230 with descriptive metadata that reflects both successful and unsuccessful task execution outcomes. This metadata includes, for example, a summary of the high-level objectives 224 the functional code 230 was configured to achieve; details of the game state 302 during task execution, such as resource availability, environmental conditions, and any changes that occurred; an explanation of why certain strategies were successful or why they failed, incorporating insights derived from the critic agent's evaluation; recommendations for refining the functional code 230 or future objectives, based on observed performance and feedback loops; a combination thereof; and the like. For example, if an objective to build a defensive structure was successfully executed, the annotation agent 216 may document the specific strategy used to gather and allocate resources; the challenges encountered, such as navigating complex terrain or handling limited resource availability, the adjustments made during execution, such as prioritizing certain sub-objectives to adapt to real-time changes in the game state; a combination thereof; and the like.

Conversely, if the objective failed, the annotation agent 216 captures, for example, the root causes of failure, such as insufficient resource allocation or flawed navigation logic; recommendations for addressing these issues in future tasks, such as improving pathfinding algorithms or ensuring preparatory steps are included in the action agent's generated code 228; any relevant contextual factors, such as unexpected enemy attacks or shifts in environmental conditions, that contributed to the failure; a combination thereof; and the like.

The annotation agent 216 integrates one or more machine learning models 220, including LLMs, to assist in generating detailed and contextually relevant annotations. The LLMs analyze unstructured data, such as error logs, execution feedback, or natural language descriptions, to produce concise yet informative annotations. For example, an LLM is able to interpret textual logs of task execution and summarize key insights in natural language, making the annotations accessible and actionable for downstream components. Other machine learning models identify recurring patterns or correlations in task performance, enriching the annotations with predictive insights for similar objectives in the future. The annotated functional code 230 is stored in the skill library 232, which serves as a centralized repository of reusable strategies, techniques, and solutions. This repository enables the automation engine 130 to, for example, dynamically generate new executable code 228 by referencing proven approaches from past tasks; leverage insights from previously encountered scenarios to handle similar challenges more effectively; reduce redundancy by reusing validated and annotated code (e.g., the functional code 230), improving efficiency in producing functional code 230 for recurring objectives; a combination thereof; and the like.

In at least some implementations, the annotation agent 216 works with the action agent 208, providing access to the skill library 232. This allows the action agent 208 to reference annotated functional code 230 when generating new executable code 228, ensuring that the automation engine 130 continually improves its performance by building on past experiences. For example, if a resource-gathering strategy proves effective in a specific terrain type, the annotation agent 216 ensures that this information is available for reuse when similar terrain is encountered in the future. In another example, if a defensive strategy fails due to insufficient preparatory steps, the annotation agent 216 documents these shortcomings and provides actionable recommendations to avoid the same mistakes.

The annotation agent 216 also contributes to the adaptability of the automation engine 130 by maintaining a structured and context-aware repository of knowledge. This repository supports continuous learning and improvement within the automation engine 130, enabling it to respond intelligently to dynamic and unpredictable gaming scenarios. For instance, the annotation agent 216 ensures that lessons learned from both successful and failed tasks are easily accessible for reference, fostering a more intelligent and informed decision-making process in future tasks. By enriching the skill library 232 with detailed, contextually relevant annotations, the annotation agent 216 enables the automation engine 130 to evolve and refine its strategies over time, addressing complex gaming challenges with greater precision and efficiency.

Through its role in annotating functional code 230 and maintaining the skill library 232, the annotation agent 216 ensures that the automation engine 130 is both adaptive and knowledge-driven. By preserving and enhancing the contextual understanding of the automation engine 130, the annotation agent 216 empowers the automation engine 130 to continuously improve, leveraging historical insights to optimize future task execution and objective achievement.

The action API 222 (FIG. 2) is a component of the automation engine 130, configured to facilitate the seamless execution of a wide range of in-game actions. The action API 222 serves as the interface between the automation engine 130 and the gaming environment, enabling the translation of high-level objectives and functional code into precise and contextually relevant gameplay actions. The robust capabilities of the action API 222 enhance gameplay interaction and optimize the overall gaming experience. In at least some implementations, the action API 222 provides a comprehensive suite of functionalities tailored to manipulate game elements dynamically. These functionalities include, for example, character movement, such as enabling precise control of character navigation across various terrains and environments within the game; keypress emulation, such as simulating keyboard and controller inputs to perform actions such as jumping, running, or attacking; UI detection and interaction, such as identifying and interacting with user interface elements (e.g., buttons, menus, inventory systems and the like); cursor manipulation, such as allowing for automated and precise control of the cursor for selecting or interacting with on-screen elements; complex action sequences, such as coordinating multiple actions to achieve composite objectives, such as gathering resources, crafting items, or defending structures; a combination thereof; and the like.

In at least some configurations, the action API 222 has a modular architecture, which allows developers to augment its capabilities with game-specific methods tailored to unique gameplay mechanics and intricacies. For example, the action API can incorporate machine learning techniques, such as object detection, to identify inventory items or environmental elements directly from the game interface. This enables nuanced interactions, such as automated inventory management or precise placement of game objects. In another example, the action API 222 can be customized to handle specialized actions, such as constructing complex structures or engaging in cooperative tasks that require synchronization with other in-game entities.

The action API 222 integrates with the automation engine's machine learning models 220 to enhance its ability to extract data from the gaming environment and inform action execution. For instance, when performing data extraction, machine learning models 220 enable the action API 222 to interpret visual and contextual game data, such as detecting objects, tracking enemy movements, or recognizing patterns in resource distribution. When performing adaptive execution, the action API 222 leverages insights from machine learning models 220 to dynamically adapt its actions based on real-time game state updates, ensuring that gameplay remains responsive and contextually appropriate.

By combining its robust action execution capabilities with advanced data processing techniques, the action API 222 unlocks new opportunities for game analysis, optimization, and automation. For instance, regarding game analysis, the ability of the action API 222 to interact with and extract data from the gaming environment enables detailed performance analysis, helping identify inefficiencies or optimization opportunities in gameplay strategies. Regarding optimization, the action API 222 enhances the overall performance and enjoyment of the gaming experience by refining gameplay strategies based on data-driven insights. Regarding automation, the action API 222 facilitates the automated execution of repetitive or complex tasks, such as resource collection, base management, or combat, freeing up players to focus on higher-level decision-making.

As such, the automation engine 130 functions as an integrated AI-driven system, seamlessly automating gameplay by dynamically generating objectives, executing tasks, and learning from outcomes to optimize future performance. This process involves the coordinated operation of specialized agents, machine learning models, and a custom Action API 222. Below are examples illustrating the operation of the automation engine 130 in a game environment.

In at least some implementations, the automation engine 130 begins by gathering comprehensive game state data, including inventory details, environmental context (e.g., resource deposits and obstacles), and historical task performance. For instance, the inventory data of the character may include limited quantities of iron ore, coal, and a burner mining drill, highlighting potential opportunities for resource collection and automation. The environmental data might indicate that nearby tiles (e.g., individual blocks or grid squares in the game map) reveal multiple deposits of coal, stone, and iron ore, along with obstructing trees. In this example, these deposits are used for crafting and automation within the game. Additionally, the task history includes previous tasks, such as mining stone and coal for 30 seconds each, with success in coal extraction but inefficiencies in stone mining due to suboptimal navigation.

The operation of the automation engine 130 can be further explained through its agents'interactions. The curriculum design agent 202 formulates high-level objectives based on the game state. By analyzing the player's current inventory, the spatial distribution of resources and obstacles on tiles, and the historical record of completed tasks, this agent identifies actionable goals. For example, recognizing the scarcity of stone in the inventory and its significance for crafting essential items, the curriculum design agent 202 generates an objective to mine stone ore. The reasoning behind this task is informed by the inventory data indicating a surplus of iron ore and coal but a shortage of stone, as well as the game's mechanics that emphasize stone as a foundational resource.

To refine its output, the curriculum design agent 202 incorporates insights from both successful and failed tasks. For example, if previous attempts to maintain power supply during expansions consistently failed, the curriculum design agent 202 may prioritize automating the power grid in its objectives. Similarly, the curriculum design agent 202 learns from the inefficiencies noted in stone mining, such as suboptimal navigation, and incorporates these lessons into its strategic planning. By iteratively adapting to the evolving game state, the curriculum design agent 202 ensures that the objectives are contextually relevant and aligned with the broader gameplay strategy.

The task agent 206 complements the curriculum design agent 202 by translating high-level objectives 224 into actionable sub-objectives 304. For the task of mining stone ore, the task agent 206 generates a sequence of sub-tasks, including locating nearby stone deposits using tile data, navigating to the deposit, and performing the mining operation for a specified duration, such as 30 seconds. This decomposition ensures that the objective 304 is broken into manageable steps that downstream components can efficiently execute. Moreover, the task agent 206 dynamically adapts these sub-tasks in response to real-time changes in the game environment, such as the unexpected depletion of nearby resources.

Through this collaborative operation, the agents of the automation engine 130 effectively manage gameplay scenarios. For instance, after identifying that the inventory includes a drill and observing iron ore deposits nearby, the curriculum design agent 202 may generate an objective to automate iron ore extraction. The task agent 206 then specifies sub-objectives 304 such as locating the iron ore deposit, accessing the inventory to craft the mining drill, navigating to the deposit, and placing the drill at the optimal location for resource extraction. This sequence highlights the ability of the automation engine 130 to not only respond to immediate resource requirements but also strategically plan for future automation needs.

As the tasks progress, the action agent 208, in conjunction with the action API 222, executes the sub-objectives by interacting with the game environment. This involves actions such as character movement, resource collection, and inventory management. The critic agent 214 evaluates the outcomes of these tasks, comparing the state of the inventory before and after execution to assess success. If inefficiencies are identified, such as delays in resource gathering due to navigation issues, the critic agent 214 provides feedback to refine future actions. This feedback is incorporated by the curriculum design agent 202 and task agent 206, enabling continuous learning and improvement.

Once the critic agent 214 validates the results, the functional code 230 produced for the tasks is enriched by the annotation agent 216 with metadata detailing the strategies used, encountered challenges, and lessons learned. This annotated code is stored in the skill library 232, where it serves as a repository of reusable solutions for similar tasks in the future. For example, if the task of automating iron ore mining is successfully completed, the annotated strategy can be reused in similar scenarios, streamlining future gameplay automation.

Through this iterative process of data analysis, objective generation, task decomposition, action execution, and feedback integration, the automation engine 130 demonstrates its ability to dynamically adapt and optimize gameplay. By leveraging advanced machine learning models and a custom action API 222, the automation engine 130 overcomes the limitations of traditional hard-coded algorithms, offering a versatile and intelligent approach to game automation.

The versatility and adaptability of the automation engine 130 are illustrated in another example showcasing the automation engine's capacity to dynamically generate objectives, decompose tasks, execute actions, and refine strategies. This example involves a scenario where the game state data reveals information about inventory items, environmental resources, and crafting opportunities, enabling the system to optimize resource acquisition and logistical infrastructure development.

In this scenario, the input data highlights the presence of stone and coal deposits, essential for resource gathering and production processes. The inventory includes crafting items such as wooden boxes and transportation belts, emphasizing the importance of logistics and infrastructure development. Additionally, the inventory includes a drill, which signals an opportunity for automated resource extraction. The proximity of an iron ore deposit further indicates the potential for streamlining resource collection through automation. This comprehensive game state data, including inventory details and environmental context, is processed by the curriculum design agent 202 to identify actionable objectives.

Recognizing the presence of the drill in the inventory and nearby iron ore deposits, the curriculum design agent 202 formulates an objective 224 to automate the iron ore mining process. The curriculum design agent 202 reasons that deploying the drill at the iron ore deposit would enhance efficiency and improve resource collection. The proposed objective 224 is informed by the game state analysis, which considers the availability of crafting components, the location of resources, and the potential for automation to optimize gameplay. The ability of the curriculum design agent 202 to deduce actionable goals from contextual data highlights its adaptability and strategic reasoning.

The task agent 206 complements this process by breaking down the high-level objective into detailed sub-tasks. For the task of automating iron ore mining, the task agent 206 generates sub-tasks 304, which include locating the iron ore deposit using tile data, navigating to its location, accessing the inventory to craft the burner mining drill, picking up the crafted drill, and placing it strategically near the deposit. Each sub-task 304 is designed to ensure that the broader objective is achieved efficiently and effectively, with steps tailored to the specific nuances of the game environment. The decomposition process ensures that complex objectives are transformed into actionable steps that downstream components can execute seamlessly.

During task execution, the action agent 208 leverages the action API 222 to interact with the game environment. The action agent 208 performs actions such as navigating the game map, managing the inventory, and deploying the drill. By referencing prior knowledge and integrating feedback from earlier iterations, the action agent 208 optimizes its code generation processes. For example, the action agent 208 dynamically adjusts its interaction strategies based on environmental constraints or task-specific challenges, such as obstacles blocking access to the iron ore deposit. This iterative approach ensures that the generated executable code 228 is both context-aware and efficient.

After executing the tasks, the critic agent 214 evaluates the outcomes to determine whether the objective was successfully achieved. The critic agent 214 performs a comparative analysis of the inventory data before and after the task execution to assess the impact of the deployed strategies. If inefficiencies are identified, such as excessive time spent on navigation or incomplete resource collection, the critic agent 214 provides actionable feedback to refine the code generation and task execution processes. For example, if the deployment of the drill does not maximize resource extraction, the critic agent 214 may suggest adjustments to the placement logic or propose alternative strategies for subsequent iterations. This feedback loop fosters continuous learning and improvement within the automation engine 130.

Once the critic agent 214 validates the results, the annotation agent 216 appends detailed metadata to the functional code 230. This includes annotations describing the strategies used, encountered challenges, and lessons learned during task execution. The annotated functional code 230 is stored in the skill library 232, creating a centralized repository of reusable strategies that support future tasks. For example, the annotation documents optimal placement techniques for mining drills or highlight specific navigation strategies that proved effective in overcoming environmental obstacles. This structured knowledge retention ensures that the system can reference past successes to address similar scenarios more effectively in the future.

This example illustrates how the automation engine 130 operates as an integrated, AI-driven system. By dynamically analyzing game state data, generating contextually relevant objectives, decomposing tasks into actionable sub-tasks, and iteratively refining its strategies through feedback and annotation, the automation engine 130 exemplifies its capacity to optimize gameplay. Through the coordinated efforts of specialized agents and the action API 222, the automation engine 130 adapts to the complexities of dynamic gaming environments, enabling a robust and intelligent approach to automation.

As such, the automation engine 130 represents a transformative solution to the limitations of traditional game automation methods. By integrating specialized agents and machine learning models, including LLMs, the automation engine 130 dynamically generates objectives, executes tasks, and learns from outcomes to continuously improve performance. Unlike conventional frameworks that rely heavily on game-specific APIs or hard-coded algorithms, the automation engine 130 achieves adaptability through direct game state analysis and the use of a custom action API 222. This approach eliminates dependencies on external APIs, mitigates inefficiencies caused by unachievable objectives, and ensures the generality and reusability of generated code. Moreover, the automation engine 130 minimizes the need for human intervention by employing iterative verification processes and leveraging advanced reasoning frameworks.

The automation engine 130 excels in adaptability, enabling it to respond intelligently to diverse and evolving game scenarios. The curriculum design agent 202 facilitates intelligent decision-making by formulating context-aware objectives, while the critic agent 214 and annotation agent 216 ensure continuous learning and knowledge retention. These features enhance the automation engine's ability to make informed decisions, optimize task execution, and refine strategies over time. By storing annotated functional code in the skill library 232, the automation engine 130 builds a repository of reusable strategies, fostering scalability and efficiency in tackling new challenges.

Through these innovations, the automation engine 130 overcomes the static nature of non-AI approaches, offering a robust, versatile, and context-aware game automation system. This comprehensive framework not only enhances gameplay optimization but also provides for adaptability and intelligence in automated systems, addressing the complexities of modern gaming environments with precision and efficiency.

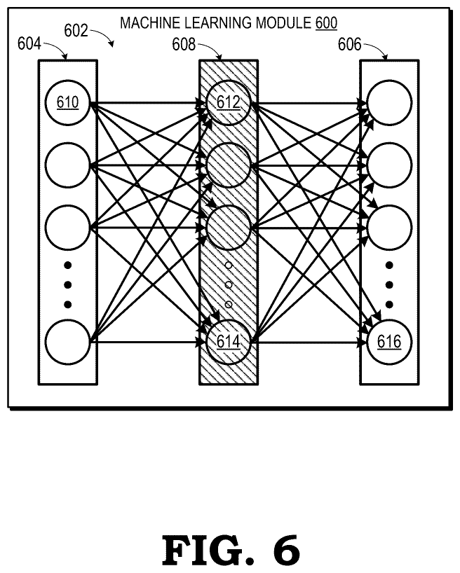

As described above, the automation engine 130 performs one or more machine learning operations to enable dynamic, context-aware decision-making and task execution. In at least some implementations, one or more components of the automation engine 130 are implemented as machine learning modules or incorporate machine learning models, including LLMs, to analyze data, predict outcomes, and adaptively improve task execution. FIG. 6 illustrates an example of a machine learning module 600, capable of being implemented by one or more components of the automation engine 130, such as the curriculum design agent 202, objective critic agent 204, task agent 206, action agent 208, type-checking process 210, static critic agent 212, critic agent 214, and annotation agent 216. The machine learning module 600, in at least some configurations, implements one or more neural networks, including deep neural networks (DNNs), recurrent neural networks (RNNs), convolutional neural networks (CNNs), or other neural architectures to process game state information, predict outcomes, and generate actionable insights.

In the depicted example, the machine learning module 600 includes at least one DNN 602 with layers of connected nodes (e.g., neurons or perceptrons) organized into input, output, and hidden layers. These nodes process input data, such as inventory details, environmental data, task history, or game tiles, to generate output predictions, such as objectives, task decompositions, or action commands. For instance, neurons may perform continuous classifications to evaluate the proximity of in-game resources to a target location, while perceptrons may classify objectives as feasible or unachievable. The machine learning module 600 performs a range of analytical processes, including regression, classification, clustering, adaptive regression splines, and multivariate prediction, leveraging its neural network configurations to improve decision-making and automation processes.

In at least some implementations, the machine learning module 600 adaptively learns using supervised or reinforcement learning. For example, during supervised learning, the machine learning module 600 processes labeled training data derived from previous game interactions, such as completed tasks, resource availability, and objective outcomes. This training data enables the machine learning to map complex input, such as game state data, to desired outputs, including optimized task plans or actionable code. During reinforcement learning, the module evaluates real-time feedback from task execution, adapting its models to improve future performance. LLMs integrated into the machine learning module 600 further enhance this process by interpreting natural language inputs, such as objective descriptions or error logs, to synthesize context-aware insights and strategies.

The DNN 602 within the machine learning module 600 includes an input layer 604, an output layer 606, and one or more hidden layers 608. The architecture allows for flexible configurations, such as fully connected layers where every node in one layer connects to every node in another or partially connected layers for more computationally efficient processing. Each node, such as node 610 in the input layer, processes incoming data using weights and adaptive algorithms, which are optimized during training to reflect learned patterns and relationships. The processed data propagates through the network, passing through nodes like 612 and 614 in the hidden layers, until the DNN generates output predictions, such as suggested objectives or refined task decompositions, using nodes in the output layer 606.

Neural network architecture configurations within the machine learning module 600 can be tailored to suit specific gaming contexts. For example, recurrent neural networks (RNNs) or long short-term memory networks (LSTMs) may be used to retain information from previous game states, allowing the system to adapt dynamically as the game environment evolves. Feed-forward networks, in contrast, may be used for rapid decision-making in static scenarios. Similarly, convolutional neural networks (CNNs) are used in implementations requiring visual perception, such as analyzing tile maps or identifying in-game objects directly from screenshots.

The architectural configuration of the machine learning module 600 is influenced by the game state and agent-specific requirements. For instance, the curriculum design agent 202 may use a DNN trained on historical objective data to predict optimal task sequences, while the objective critic agent 204 employs an LLM to validate objective feasibility based on natural language feedback and structured game data. The action agent 208 integrates both DNNs and LLMs to translate sub-objectives into functional code or executable commands by synthesizing structured data (e.g., resource locations) and unstructured data (e.g., textual critiques).

To further enhance versatility, the machine learning module 600 supports various neural network configurations optimized for specific tasks or agents. For instance, CNN architectures may include pooling parameters to process spatial game data, while RNNs utilize sequence memory to retain task histories for adaptive planning. Additionally, the integration of LLMs allows for nuanced interpretations of in-game text or error logs, generating refined strategies or code solutions in natural language that can be further processed by downstream agents.

The machine learning module 600 is integral to the automation engine 130, enabling it to process diverse input data types, generate actionable insights, and adapt to evolving gaming environments. By combining neural networks with LLM capabilities, the machine learning provides a robust foundation for dynamic, intelligent, and efficient gameplay automation.

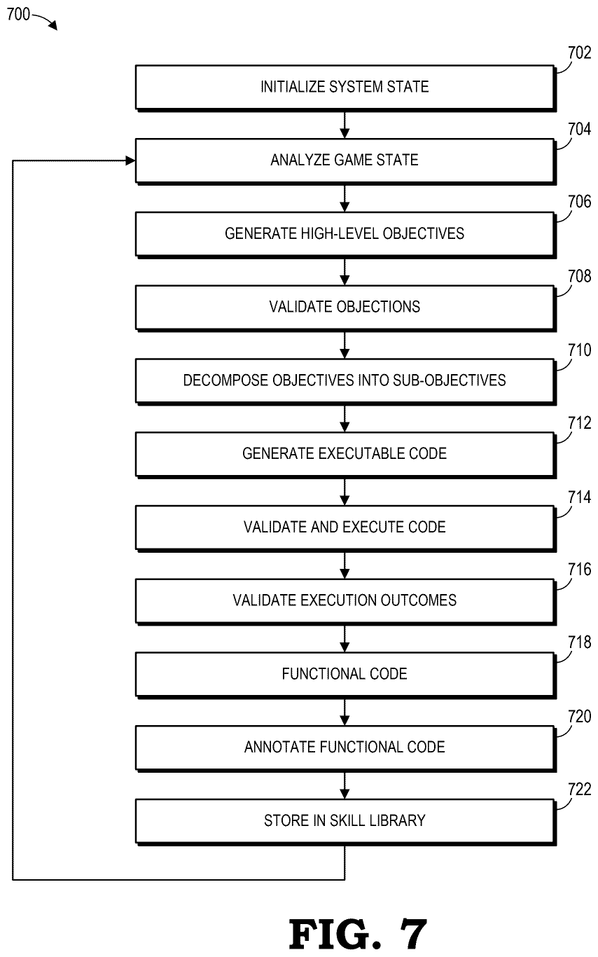

FIG. 7 illustrates a flow diagram of a method 700 for dynamically generating and executing gameplay automation tasks within the automation engine 130. The processes described below with respect to method 700 are detailed further with reference to FIGS. 1 through 6 above. For purposes of description, the method 700 is described with respect to an example implementation in the automation engine 130, but it will be appreciated that, in other implementations, the method 700 is performed within systems with different configurations or applied to alternative game environments. Furthermore, the method 700 is not limited to the sequence of operations shown in FIG. 7, as at least some operations can occur in parallel or in a different sequence. Additionally, in at least some implementations, the method 700 can include one or more different operations beyond those depicted in FIG. 7.

At block 702, the automation engine 130 begins by initializing and analyzing current application state data, such as game state data. This analysis includes gathering game state data, such as inventory details (e.g., iron ore, coal, etc.) environmental context (e.g., stone deposit at pixel coordinates X1, Y1; tree at pixel coordinates X2, Y2, etc.), historical task performance (e.g., mine stone for 30 seconds, mine coal for 30 seconds etc.), and the like. In at least some implementations, the game state data is extract from the game environment independently of one or more APIs associated with the game environment.

At block 704, the curriculum design agent 202 evaluates the game state data to formulate high-level objectives 224 (e.g., mine stone ore for 30 seconds) that align with the current needs of the player(s) and the game environment. This involves, for example, assessing reasoning from past successes and failures, as well as leveraging one or more machine learning models 220, including LLMs, to ensure the objectives are contextually relevant and strategically aligned.

At block 706, the objective critic agent 204 validates the high-level objectives 224 generated by the curriculum design agent 202. This validation includes, for example, analyzing the feasibility and achievability of the objectives 224 in light of resource availability, environmental constraints, and historical performance data, refining the objectives 224 as needed. At block 708, the task agent 206 decomposes validated objectives into actionable sub-objectives 304 (e.g., locate stone in nearby tiles, move to stone or deposit, and mine stone ore for 30 seconds). These sub-objectives 304 are detailed steps that ensure efficient execution and alignment with the broader strategy defined by the high-level objectives 224.

At block 710, the action agent 208 translates the sub-objectives 304 into executable code 228 (e.g., scripts) using ML/LLM models 220. Stated differently, the action agent 208 dynamically generates programming code based on the sub-objectives 304 derived from contextual data (e.g., game state data, task dependencies, resource availability, environmental conditions, feedback from prior executions, and the like) associated with the computational environment This step generates contextually appropriate commands tailored to perform the tasks required by the sub-objectives 304. At block 712, the static critic agent 212 evaluates the generated executable code 228 to ensure structural soundness, logical consistency, and compliance with established coding standards. This processes minimizes the risk of runtime errors or inefficiencies during execution.

At block 714, executable code 228 is validated by the static critic agent 212 and executed in the gaming environment using the action API 22. These executable code 228, in at least some implementations, are scripts that include raw commands tailored to perform the tasks defined by the sub-objectives 304. During or after execution, the validated and refined executable code 228 is transformed into functional code 230. This transformation occurs, for example, by incorporating execution feedback and structural refinements. This process ensures the functional code 230 reflects actionable, reusable, and tested logic. At block 716, the critic agent 214 evaluates the outcomes of the task execution. The resulting functional code 230 serves as the basis for further evaluations, annotations, and eventual storage in the skill library 232.

At block 718, the annotation agent 216 enriches the functional code 230 with contextual metadata. These annotations describe the success criteria, execution details, and lessons learned from the task, ensuring the code's usability in future scenarios. For example, if the generated task is to mine stone or for 30 seconds, an annotation can be associated with the functional code 230 with reasoning for the objective (e.g., the inventory current has iron ore and coal but no stone, which is useful for crafting items and there are many stone deposits nearby). At block 720, the annotated functional code 230 is stored in the skill library 232, creating a repository of reusable strategies and insights. This repository enables the automation engine 130 to leverage past successes when generating new tasks and objectives. At block 722, feedback from task evaluations, code annotations, and execution outcomes is integrated back into the automation engine 130. This feedback improves the performance of the ML/LLM models 220, refining future objective generation, task decomposition, and code generation processes. The process then returns to block 704 to perform the process for the next set of game state data.

One or more of the elements described above is circuitry designed and configured to perform the corresponding operations described above. Such circuitry, in at least some implementations, is any one of, or a combination of, a hardcoded circuit (e.g., a corresponding portion of an application-specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations, the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components”, “units”, “devices”, “circuitry”, etc.) are described or claimed as “configured” to perform one or more tasks or operations. This formulation of [entity] configured to [perform one or more tasks] is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to”. An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some implementations, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium may be in source code, assembly language code, object code, or another instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is, therefore, evident that the particular implementations disclosed above may be altered or modified, and all such variations are considered within the scope of the disclosed subject matter. Accordingly, the protection sought herein is as set forth in the claims below.

What is claimed is:

1. A method, at a processing system, comprising:
extracting, independent of one or more application programming interfaces associated with a computational environment, application state data representing a current state of the computational environment;
identifying one or more objectives based on the application state data;
decomposing the one or more objectives into a plurality of sub-objectives;
generating executable code corresponding to the plurality of sub-objectives; and
executing the executable code to perform one or more actions in the computational environment.

2. The method of claim 1, wherein the computational environment is a video gaming environment, and the application state data comprises at least one or more in-game variables.

3. The method of claim 1, further comprising:
validating the one or more objectives based on constraints within the computational environment before decomposing the one or more objectives into the plurality of sub-objectives.

4. The method of claim 1, wherein generating the one or more objectives comprises:
analyzing, with one or more machine learning models, the application state data; and
generating, with the one or more machine learning models, the one or more objectives based on the analyzed application state data.

5. The method of claim 1, further comprising:
dynamically adapting the plurality of sub-objectives based on real-time changes in the application state data during execution of the executable code.

6. The method of claim 1, wherein generating the executable code comprises:
retrieving functional code from a stored library of previously validated functional code.

7. The method of claim 1, further comprising:
evaluating one or more outcomes of executing the executable code by comparing pre-execution and post-execution application state data to determine task completion.

8. The method of claim 7, further comprising:
responsive to evaluating the one or more outcomes, generating feedback to at least one of refine future executable code or to modify the plurality of sub-objectives based on the one or more outcomes.

9. The method of claim 1, further comprising:
generating one or more annotations describing execution context associated with the executable code; and
storing executable code with the annotations in a skill library for reuse.

10. The method of claim 1, wherein executing the executable code comprises:
interacting with the computational environment through an action application programming interface (API) to perform one or more actions within the computational environment.

11. A processing system, comprising:
a processing unit; and
an automation circuit coupled to the processing unit and configured to:
extract, independent of one or more application programming interfaces associated with a computational environment executing at the processing system, application state data representing a current state of the computational environment;
generate one or more objectives based on the application state data;
decompose the one or more objectives into a plurality of sub-objectives;
generate executable code corresponding to the plurality of sub-objectives; and
execute the executable code to perform one or more actions in the computational environment.

12. The processing system of claim 11, wherein the computational environment is a video gaming environment, and the application state data comprises at least one or more in-game variables.

13. The processing system of claim 11, wherein the automation circuit is further configured to:
validate the one or more objectives based on constraints within the computational environment before the one or more objectives are decomposed into the plurality of sub-objectives.

14. The processing system of claim 11, wherein the automation circuit is configured to generate the one or more objectives by:
analyzing, with one or more machine learning models, the application state data; and
generating, with the one or more machine learning models, the one or more objectives based on the analyzed application state data.

15. The processing system of claim 11, wherein the automation circuit is further configured:
dynamically adapt the plurality of sub-objectives based on real-time changes in the application state data during execution of the executable code.

16. The processing system of claim 11, wherein the automation circuit is configured to generate the executable code by:
retrieving functional code from a stored library of previously validated functional code.

17. The processing system of claim 11, wherein the automation circuit is further configured to:
evaluate one or more outcomes of executing the executable code by comparing pre-execution and post-execution application state data to determine task completion; and
modify the plurality of sub-objectives based on the one or more outcomes.

18. The processing system of claim 11, wherein the automation circuit is further configured to:
generate one or more annotations describing execution context associated with the executable code; and
storing executable code with the one or more annotations in a skill library for reuse.

19. A method, comprising:
generating one or more objectives based on an analysis of application state data representing a current state of a computational environment;
dynamically generating programming code based on sub-objectives derived from contextual data associated with the computational environment;
obtaining at least one reusable code component associated with prior validated functional code and that is relevant to the one or more objectives;
generating executable code by combining the at least one reusable code component with the dynamically generated programming code;
executing the executable code to perform one or more actions within the computational environment; and
responsive to evaluating at least one outcome of the one or more actions, refining the one or more objectives or the executable code.

20. The method of claim 19, wherein evaluating at least one outcome comprises:
detecting whether the one or more objectives have been achieved based on analyzing at least one change in the application state data resulting from executing the executable code.
